(19) United States
(12) Patent Application Publication
(10) Pub. No.: US 2023/0312370 A1
(43) Pub. Date: Oct. 5, 2023

(54) POSITIVE ELECTRODE ACTIVE MATERIAL, PREPARATION METHOD THEREOF, AND POSITIVE ELECTRODE

(71) Applicants: TOYOTA JIDOSHA KABUSHIKI KAISHA, Toyota-shi (JP); CENTRE NATIONAL DE LA RECHERCHE SCIENTIFIQUE, Paris (FR)

(72) Inventors: Laurent CASTRO, Brussels (BE); Valentin SAIBI, Pessac (FR); Marie GUIGNARD, Pessac (FR); Claude-Henri DELMAS, Pessac (FR)

(73) Assignees: TOYOTA JIDOSHA KABUSHIKI KAISHA, Toyota-shi (JP); CENTRE NATIONAL DE LA RECHERCHE SCIENTIFIQUE, Paris (FR)

(21) Appl. No.: 18/128,388

(22) Filed: Mar. 30, 2023

(30) Foreign Application Priority Data
Mar. 31, 2022 (EP) 22305417.2

(51) Int. Cl. C01G 53/00; H01M 10/0525

(52) U.S. Cl. CPC C01G 53/50; C01G 53/006; H01M 10/0525; C01P 2006/40; C01P 2002/76

(57) ABSTRACT

A positive electrode active material has O6-type structure having Liₓ [A_{z}B_{w}(Li_{1/6}Ni_{1/6}Mn_{4/6})_{1-z-w}]O₂, wherein 1≥x>0; z<0.005; when present, A is at least one element chosen from the group consisting of: Mg, Ca, Sr, Sc, Y, La, Ti, Zr, Hf, V, Nb, Ta, Cr, Mo, W, Mn, Fe, Co, Zn and Al; w<0.05; and when present, B is at least one element chosen from the group consisting of: Mg, Ca, Sr, Sc, Y, La, Ti, Zr, Hf, V, Nb, Ta, Cr, Mo, W, Mn, Fe, Zn, and Al.

### CROSS-REFERENCE TO RELATED APPLICATION

This application claims priority to European Patent Application No. 22305417.2 filed on Mar. 31, 2022, incorporated herein by reference in its entirety.

### BACKGROUND

### 1. Technical Field

The present disclosure relates to a positive electrode active material, a preparation method of the positive electrode active material, and a positive electrode.

### 2. Description of Related Art

U.S. Ser. No. 11/038,167 B2 discloses a cathode active material for a positive electrode for a lithium ion secondary battery, comprising a lithium-containing composite oxide represented by aLi(Li_{1/3}Mn_{2/3})O₂·(1-a)LiMO₂, wherein M is Ni, Co and/or Mn, and O<a≤0.22 or 0.64≤a<1). The X-ray diffraction pattern of the lithium-containing composite oxide corresponds to an O3 type structure.

US 2021/0288320 A1 discloses a positive electrode material for secondary batteries, the material including a Li-rich transition metal oxide having a lithium-to-oxygen atomic ratio: Li/O of 0.8 or more, and a dicarboxylic acid and/or an anhydride of the dicarboxylic acid. The Li-rich transition metal oxide is in particular of formula Liₓ₁M¹A¹₂, where 1.5≤x1≤2.3, and belonging to a space group Immm, M¹ including at least one selected from the group consisting of Ni, Co, Mn, Cu, and Fe, Al including at least oxygen, Al having an oxygen content of 85 atom % or more. The space group of the positive electrode material reported here is Immm (71), an orthorhombic one.

JP 6316687 B2 discloses a lithium-containing compound oxide represented by LiₓNiₐCo_{b}Mn_{c}M_{d}O_{y} (x: 1.1 to 1.7, a: 0.15 to 0.5, b: 0 to 0.33, c: 0.33 to 0.85, M: other metal element, d: 0 to 0.05, a+b+c+d=1, and y: number of moles of 0 required to satisfy the valences the metal elements). The crystal structure of the compound oxide corresponds to an O3 type structure.

Paulsen et al., Chem. Mater. 2000, 12, 2257-2267 (Paulsen et al.) describes layered T2-, O6-, O2-, and P2-Type A_{2/3}[M′²⁺_{1/3}M⁴⁺_{2/3}]O₂ bronzes, where A=Li, Na; M′=Ni, Mg; M=Mn, Ti.

EP 2720981 B1 discloses a cobalt-containing lithium metal oxide powder for use as a cathode material in a rechargeable battery, consisting of a core material and a surface layer, the core having a layered crystal structure consisting of the elements Li, a metal M and oxygen, wherein the Li content is stoichiometrically controlled, wherein the metal M has the formula M=Co₁₋ₐM′ₐ, with 0≤a≤0.05, wherein M′ is either one or more metals of the group consisting of Al, Ga and B; and the surface layer consisting of a mixture of the elements of the core material and inorganic N-based oxides, wherein N is either one or more metals of the group consisting of Mg, Ti, Fe, Cu, Ca, Ba, Y, Sn, Sb, Na, Zn, Zr and Si.

US 2016/0056460 A1 discloses a positive electrode active material having a layered structure and comprising a lithium-containing transition metal oxide in which a main arrangement is represented by a O2 structure, with formula Liₓ [Li_{α}(MnₐCo_{b}M_{c})_{1-α}]O₂, wherein 0.5<x<1.1, 0.1<α<0.33, 0.17<a<0.93, 0.03<b<0.50, and 0.04<c<0.33, the element M being selected from the group consisting of Ni, Mg, Ti, Fe, Sn, Zr, Nb, Mo, W, and Bi.

U.S. Pat. No. 9,831,489 B2 discloses a layered crystalline lithium (Li)-containing transition metal composite oxide that contains sodium Na, represented by the general formula LiₓNaₐ[Li_{y}M_{1-y}]O_{2-c+α}I_{2c}, where M contains at least one of Ni, Co, and Mn, 0.67<x<1.1, 0<y<0.33, 0.0001≤a≤0.1, −0.1≤α≤0.1, and c is an iodine content (mol/g)/(mol/g) of the positive-electrode active material)/2, where 0.4 μmol/g<the iodine content <25 μmol/g, and the I is contained within the layered structure of the Li-containing transition metal composite oxide.

WO 2020/218474 A1 discloses a positive electrode active material for a secondary battery containing a first and a second composite oxide component. The first composite oxide component is of formula Li_{α}[LiₓMn_{y}Co_{z}Me_{(1-x-y-z)}]O₂, wherein Me is at least one selected from among Ni, Fe, Ti, Bi, Nb, W, Mo, and Ta, 0.5<α<0.85, 0.05<x<0.2, 0.4<y<0.75, and 0<z<0.25, and having at least one crystal structure selected from among O2, T2, and O6 structures. The second composite oxide component is of formula LiaMObAc wherein M is at least one selected from among Ni, Co, Mn, Fe, Cu, Ti, Nb, Al, Ga, Bi, Zr, Ce, Y, W, Ta, Sn, Ca, Ba, and Na, A is at least one selected from among F, Cl, and S, 1.3<a<7, 2≤b<5, and 0≤c≤0.3.

Tarascon, J. Electrochem. Soc., Vol. 134, No. 6 (1987), 1345-1351 discloses a synthesis of LiₓMo₂O₄ via ion exchange of Na⁺ for Li⁺ in NaₓMo₂O₄.

### SUMMARY

Among goals sought after for positive electrode materials for lithium ion secondary battery, the following may notably be cited: high capacity, avoidance of capacity degradation through ageing, and reducing cost and ensuring continuity of manufacture by avoiding the need to use metals in limited supply, notably cobalt (Co), a limited mining resource.

In this context, the present disclosure provides a positive electrode active material with O6-type structure having the following formula (1):

Liₓ[A_{z}B_{w}(Li_{1/6}Ni_{1/6}Mn_{4/6})_{1-z-w}]O₂ (1)
wherein
1≥x>0;
z<0.005;
when present, A is at least one element chosen from the group consisting of: Mg, Ca, Sr, Sc, Y, La, Ti, Zr, Hf, V, Nb, Ta, Cr, Mo, W, Mn, Fe, Co, Zn and Al;
w<0.05; and
when present, B is at least one element chosen from the group consisting of: Mg, Ca, Sr, Sc, Y, La, Ti, Zr, Hf, V, Nb, Ta, Cr, Mo, W, Mn, Fe, Zn, and Al.

According to the present disclosure, cobalt (Co) may be present, in the positive electrode active material with O6-type structure of the disclosure, in a small quantity, according to which z<0.005 in the above formula.

In an embodiment, the positive electrode active material may be with O6-type structure having the following formula (1):

Liₓ[Co_{z}B_{w}(Li_{1/6}Ni_{1/6}Mn_{4/6})_{1-z-w}]O₂ (1)
wherein
1≥x>0;
z<0.005;
w<0.05; and
when present, B is at least one element chosen from the group consisting of: Mg, Ca, Sr, Sc, Y, La, Ti, Zr, Hf, V, Nb, Ta, Cr, Mo, W, Mn, Fe, Zn, and Al. x may be 1≥x>0.

In embodiments, cobalt (Co) may be substantially or fully absent from the positive electrode active material with O6-type structure of the disclosure, whilst metal elements in the “B” class may be present in higher amounts, corresponding to w<0.05 in the formula above.

In an embodiment, no element A and/or B may be present, and so z=0 and/or w=0.

In a positive electrode active material according to the present disclosure, the material may show the monoclinic C2/m (12) space group, with the following cell parameters:

a=4.93 Å,b=8.52 Å,c=9.81 Å,β=100.2°.

In another aspect, the present disclosure provides a preparation method of a lithium-rich mixed oxide positive electrode active material comprising at least the following steps:
mixing, as a first step, a combination of oxygen-containing anion compounds of nickel, manganese, sodium and lithium, in a heating process in order to prepare a mixed oxide of sodium, lithium, nickel and manganese;
carrying out, as a second step, Na—Li ion exchange through application of a further lithium source to the mixed oxide of sodium, lithium, nickel and manganese prepared in the first step.

In method embodiments, the oxygen-containing anion may compound of nickel, manganese, sodium and lithium comprise oxides, hydroxides and/or carbonates. In method embodiments, the sources of oxygen-containing anion may compound of nickel and/or manganese are oxides, and/or the sources of oxygen-containing anion may compound of sodium and lithium are carbonates and/or hydroxides.

According to the preparation method of the positive electrode active material in the present disclosure
in the first step, a combination of nickel oxide NiO and manganese oxide MnO₂ with sodium carbonate Na₂CO₃ and lithium carbonate Li₂CO₃ may be mixed and heated at a temperature of 700° C. to 1000° C., for between 10 hours and 10 days, in order to prepare a mixed oxide of sodium, lithium, nickel and manganese; and
in the second step, the mixed oxide of sodium, lithium, nickel and manganese prepared in the first step may be combined with lithium chloride (LiCl) powder, grinded, formed to a pellet and heated under vacuum at a temperature of at least 200° C. and at most 400° C. for at least 2 hours and at most 15 hours, in order to carry out solid state ionic Na—Li exchange and prepare a lithium-rich mixed oxide in the presence of lithium chloride and sodium chloride.

In preparation methods of of the positive electrode active material according in the present disclosure, the steps may further include:
treating, as a third step, the lithium-rich mixed oxide in the presence of lithium chloride and sodium chloride obtained in the second step with a solvent to remove remaining lithium chloride and sodium chloride salts, in order to obtain a lithium-rich mixed oxide positive electrode active material.

In preparation methods of the positive electrode active material according in the present disclosure, a combination of nickel oxide NiO and manganese oxide MnO₂ may be used in first step and may be prepared by:
preparing, as a prior step, a mixture of nickel oxide NiO and manganese oxide MnO₂ by heating of a mixture of nickel and manganese nitrates at a temperature of 350° C. to 550° C. In the prior step, the mixture of nickel oxide NiO and manganese oxide MnO₂ may be prepared by heating of the mixture of nickel and manganese nitrates at a temperature of 400° C. to 500° C.

The method of the present disclosure allows the positive electrode active material according to the present disclosure to be obtained.

It has been observed by the present inventors that the O6 structure type layered active materials of the present disclosure provide improved capacity with respect to O3 type ones, as illustrated by the results shown in FIGS. 3A-3D and 4A-4D. Li-rich O6 layered active materials of the present disclosure may also avoid irreversible formation of spinel structure, an ageing mechanism, and do not require cobalt (Co), a limited mining resource.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows X-ray diffraction (XRD) patterns using a Cu source of materials obtained according to Example 1 and Comparative Examples 1 to 3 (E1, CE1, CE2 and CE3);

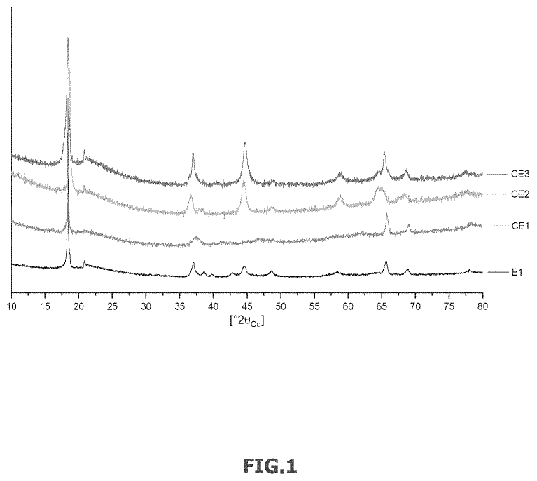

FIG. 2A shows experimental XRD patterns obtained using Synchrotron Beamline of the E1 material and its associated simulated faulted O6 type structure XRD pattern;

FIG. 2B shows experimental XRD patterns obtained using Synchrotron Beamline (with identified impurities Li₂CO₃ and Li₂MnO₃) of the E1 material;

FIG. 3A shows the first cycles obtained with E1 material between 2.6 V & 4.6 V (12 cycles);

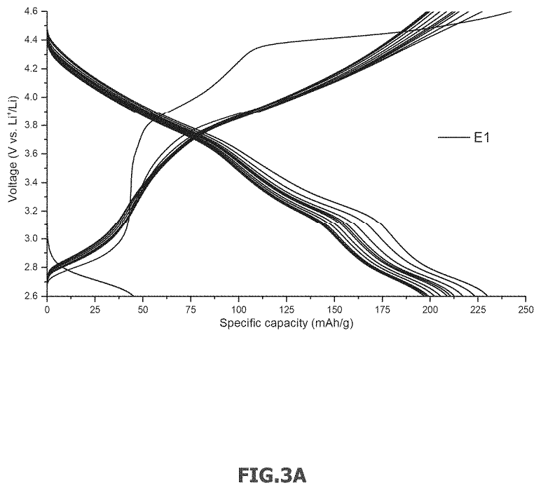

FIG. 3B shows the first cycles obtained with CE1 material between 2.6 V & 4.6 V (12 cycles);

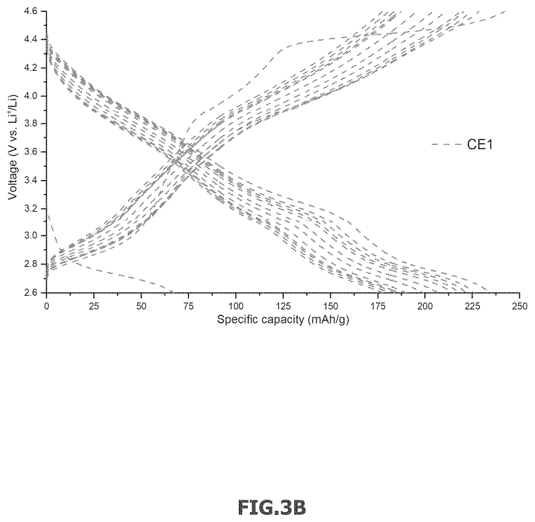

FIG. 3C shows the first cycles obtained with CE2 material between 2.6 V & 4.6 V (12 cycles);

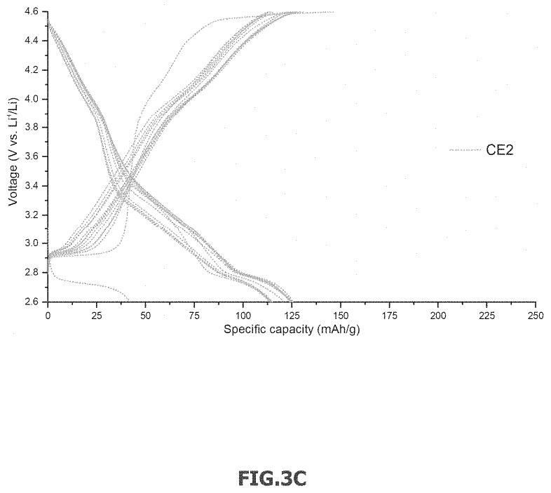

FIG. 3D shows the first cycles obtained with CE3 material between 2.6 V & 4.6 V (12 cycles);

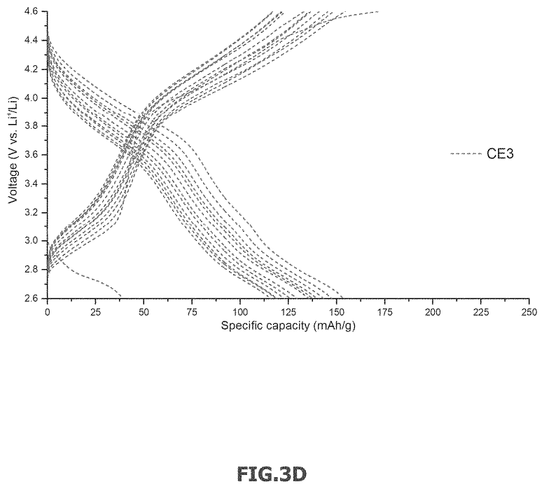

FIG. 4A shows the first cycles obtained with E1 material between 2.5 V & 4.8 V (12 cycles);

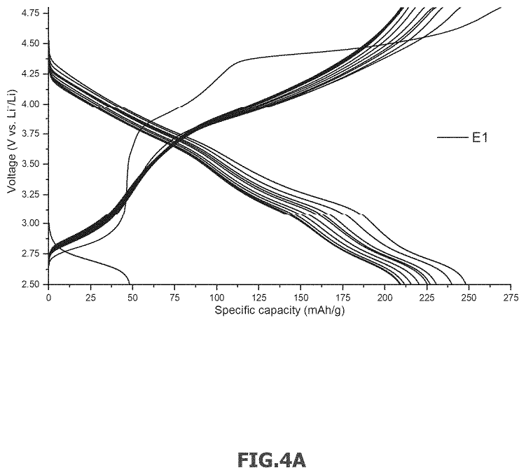

FIG. 4B shows the first cycles obtained with CE1 material between 2.5 V & 4.8 V (12 cycles);

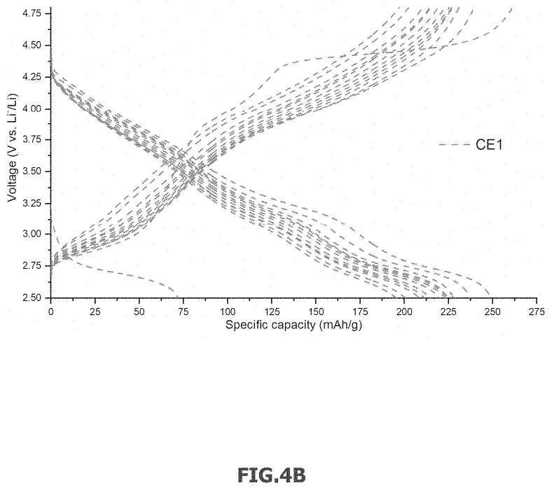

FIG. 4C shows the first cycles obtained with CE2 material between 2.5 V & 4.8 V (12 cycles);

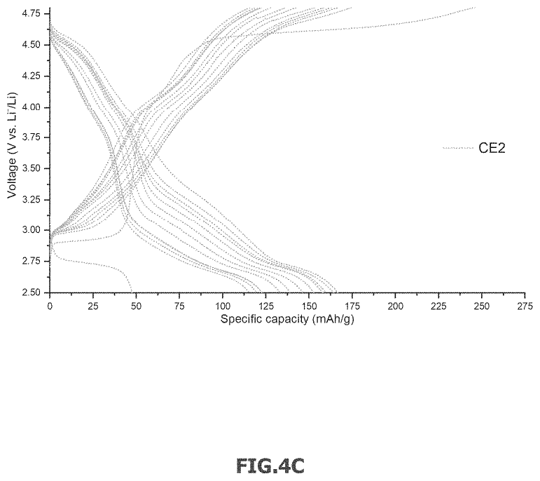

FIG. 4D shows the first cycles obtained with CE3 material between 2.5 V & 4.8 V (12 cycles);

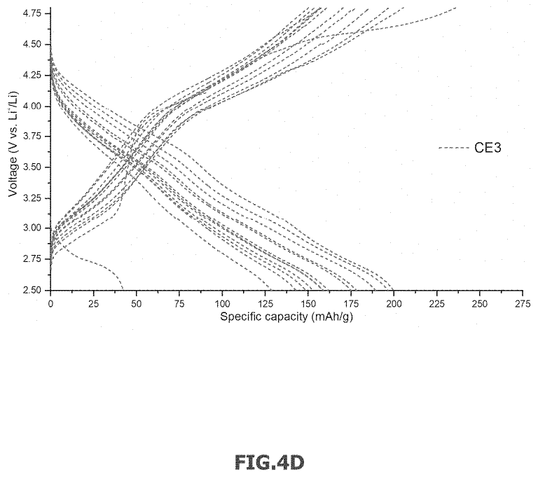

FIG. 5 shows a transition electron microscope (TEM) image of the O6 phase as obtained for Example E1;

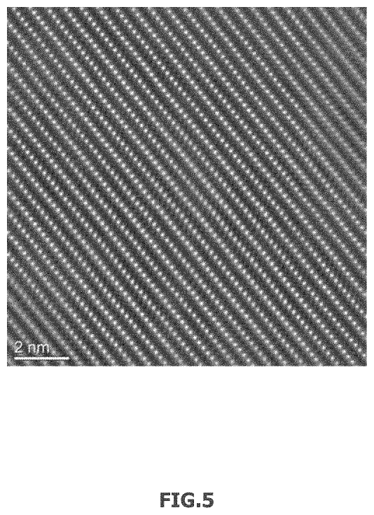

FIG. 6 shows a scanning electron microscope (SEM) image of P2 phase with a thermal treatment for several days;

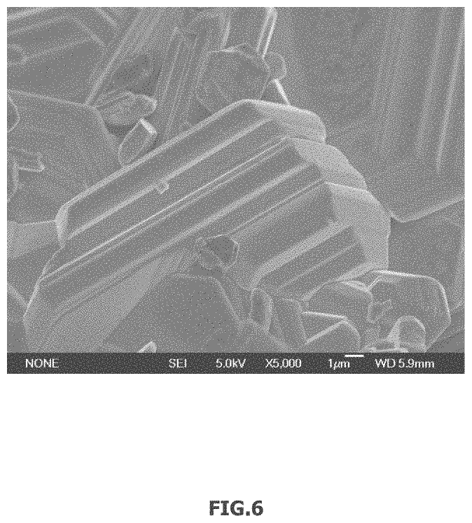

FIG. 7A shows SEM images of O6 phase as obtained for Example (E1);

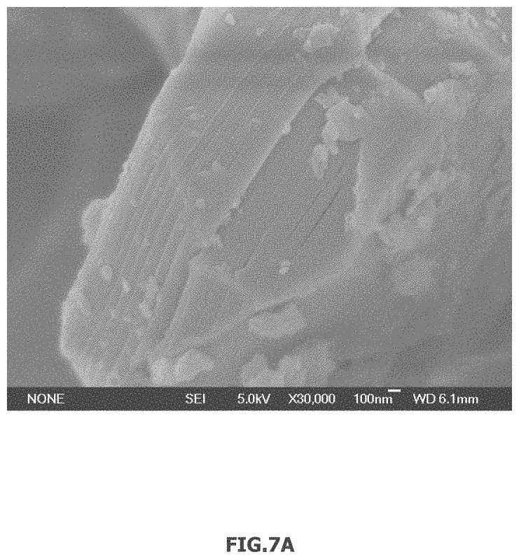

FIG. 7B shows SEM images of O6 phase as obtained for Example (E1); and

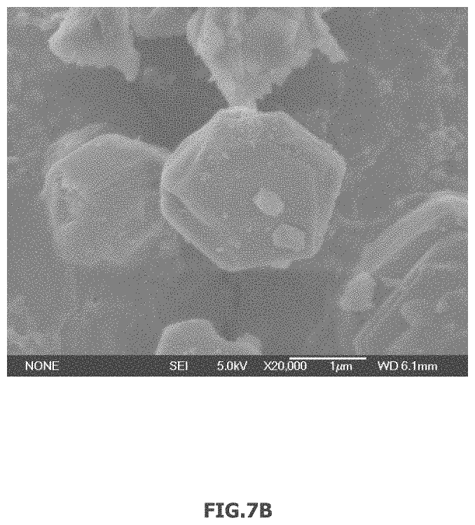

FIG. 7C shows SEM images of O6 phase as obtained for Example (E1).

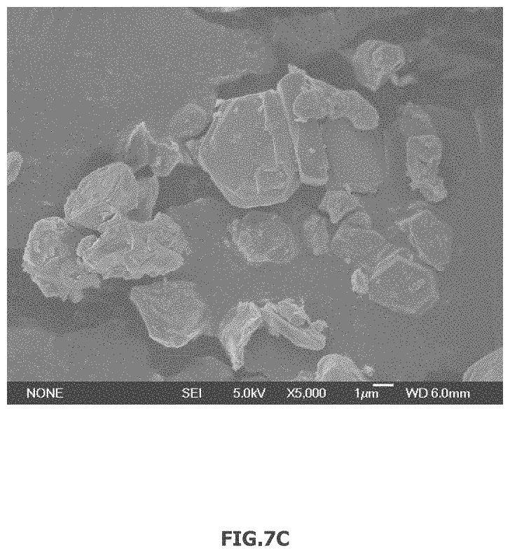

### DETAILED DESCRIPTION

As described in Paulsen et al., the classification system of structures of layered AₓMO₂ bronzes into the groups is P2, O2, O6, P3, O3. In this classification system, the alkali metal A can be present in a prismatic or octahedral site, hence the letter “P” or “O”, and the number refers to the number of MO₂ sheets (M being a transition metal) in the unit cell. MO₂ sheets in these structures are separated by the alkali metals.

The present disclosure relates to O6 structure type layered active materials. Crystal structure of positive electrode active materials of the present disclosure may appropriately be assessed using standard Faults software or DIFFAX software (DIFFaX, a computer program named as an acronym for Diffracted Intensities From Faulted Xtals), which computes diffraction from layered crystals that contain stacking faults. With more than 50% of computed defects not having O6 structure type, for example having O2-type defects, the structure type will no longer be defined as O6-type, with in particular an O2-type defect, but instead as another basic structure e.g. an O2 structure. In embodiments, the computed level of defect, such as O2-type defect, in the O6 structure of positive electrode active materials of the present disclosure is 40% or less, in some embodiments 30% or less, in some embodiments 20% or less, and in some embodiments 10% or less.

As set out above, the present disclosure provides a method of preparation of a lithium-rich mixed oxide positive electrode active material comprising steps of: (1) mixing, as a first step, a combination of oxygen-containing anion compounds of nickel, manganese, sodium and lithium, in a heating process in order to prepare a mixed oxide of sodium, lithium, nickel and manganese; and (2) carrying out, as a second step, an Na—Li ion exchange through application of a further lithium source to the mixed oxide of sodium, lithium, nickel and manganese prepared in the first step. This first step may provide a P2 structure material.

In embodiments, oxygen-containing anion compounds of nickel and manganese as sources in the first step are oxides, such as in particular nickel oxide NiO and manganese oxide MnO₂.

In embodiments, oxygen-containing anion compounds of sodium and lithium as sources in the first step are carbonates and hydroxides, including mixtures of the two, which may be precipitated together. Carbonates may be sources of both Na and Li in the framework in embodiments of the present disclosure.

In some methods therefore, in the first step, a combination of nickel oxide NiO and manganese oxide MnO₂ are mixed with sodium carbonate Na₂CO₃ and lithium carbonate Li₂CO₃ and heating is carried out in order to prepare a mixed oxide of sodium, lithium, nickel and manganese. This first step may provide a P2 structure material.

In alternative possible methods for the synthesis of the P2 phase, a co-precipitation method can be used as summarized below:
two solutions, one of Ni(NO₃)₂·6H₂O and one of Mn(NO₃)₂·4H₂O, and another one of Na₂CO₃, may be simultaneously dropped into a recipient, such as a beaker, with an appropriate quantity of distilled water. In embodiments, this co-precipitation may be carried out using a syringe pusher;
the precipitate formed in the co-precipitation step may then be appropriately washed with distilled water, for example 5 times, and then dried, for example at 80° C. for two days. The dried powder thus obtained can be mixed with Na₂CO₃ and Li₂CO₃ in a glove box filled under argon to reach the required stoichiometry for a final Naₓ[LiₓNi_{z}Mnₜ]O₂ composition. The mixture can then be calcined in air, for example at a temperature of around 900° C. for about 12 hours. Finally, the material obtained may be quenched in air down to room temperature.

In the first part of this process to produce a P2 phase material, as well as nitrate, sulfate or hydroxide can be used in the first step. Co-precipitation methods of related species are also disclosed in Yabuuchi et al., JACS, 2011, 133, 4404-4419; and Kim et al., Journal of Power Sources, 203 (2012), 115-120.

A feature of the second step is to carry out ionic exchange with added lithium, in order to replace sodium ions in the mixed oxide prepared in the first step with lithium ions. An O6 phase material can also be obtained from the P2 phase material prepared in the previous step. Ionic Na—Li exchange can be carried out using a lithium salt added in solution. Alternatively, in some embodiments, ion exchange in the solid phase, with a lithium source such as lithium chloride may be carried out. In an embodiment of a procedure according to the present disclosure, in the second step, the mixed oxide obtained in the first step is mixed with lithium chloride (LiCl) powder, followed by grinding, forming a pellet and heating under vacuum, in order to prepare a lithium-rich mixed oxide in the presence of lithium chloride and sodium chloride. The chlorides may appropriately be removed in a third step involving treating with a solvent.

Alternative methods for the synthesis of O6 phase from P2 phase include liquid or molten salt methods as described hereinbelow:
Liquid method: In methanol, LiCl may be dissolved at a high concentration, for example 5M. The P2 phase material previously obtained may be added into the solution and stirred, at room temperature, for example for a duration of about 1 day (24 hours is commonly appropriate);
Molten salt method: the P2 intermediate may be mixed LiNO₃ and LiCl, with a 88:12 (mol:mol) (88:12) mixture of LiNO₃:LiCl in some embodiments, notably with an Na:Li ratio equal to 1:10. Such a mixture may then be heated in air, appropriately at around 280° C., appropriately for 4 hours, with P<10⁻² mbar. The product of the reaction may appropriately be washed and filtered with methanol, and the resulting powder dried e.g. for a day at room temperature in a glove box.

For the first step, NiO and MnO₂ from commercial sources may be used as starting materials. Increased reactivity and higher purity may however be observed for the use of nickel and manganese oxides prepared according to a particular protocol. Thus, in some embodiments, the combination of nickel oxide NiO and manganese oxide MnO₂ used in the first step is prepared by a prior step of:

(0) preparing a mixture of nickel oxide NiO and manganese oxide MnO₂ by heating of a mixture of nickel and manganese nitrates at a temperature of 350° C. to 550° C., or 400° C. to 500° C. in some embodiments.

<Positive Electrode for Lithium Ion Secondary Battery>

The positive electrode for a lithium ion secondary battery of the present disclosure contains the lithium-rich positive electrode active material of the present disclosure. An electrically conductive material and/or a binder may also be present.

Appropriate electrically conductive materials include: carbon black (such as acetylene black or Ketjen black), graphite, vapor-grown carbon fibers or carbon nanotubes.

Appropriate binders include: a fluorinated resin (such as polyvinylidene fluoride or polytetrafluoroethylene), a polyolefin (such as polyethylene or polypropylene), a polymer or copolymer having unsaturated bonds (such as a styrene/butadiene rubber, an isoprene rubber or a butadiene rubber) or an acrylic polymer or copolymer (such as an acrylic copolymer or a methacrylic copolymer).

A positive active material layer containing the lithium rich positive electrode active material of the present disclosure, and optional electrically conductive material(s) and/or binder(s) may be formed on a positive electrode current collector, such as an aluminum foil or a stainless steel foil, an aluminum alloy, or titanium. The positive electrode material layer may be formed on one surface or both surfaces of a sheet-form positive electrode current collector, the current collector appropriately having a thickness of at least 3 μm and at most 50 μm.

Lithium Ion Secondary Battery with Non-Aqueous Liquid Electrolyte

In one embodiment, a lithium ion secondary battery of the present disclosure comprises a positive electrode as set out above, a negative electrode and a non-aqueous liquid electrolyte.

Negative Electrode

The negative electrode contains an anode active material, and may appropriately contain an electrically conductive material and/or a binder, and is appropriately formed on a negative electrode current collector.

The negative electrode may include a negative-electrode current collector, such as a metal foil, and a negative-electrode active material layer formed on the negative-electrode current collector. The negative-electrode current collector may be a metal foil that rarely forms an alloy with lithium in the electric potential range of the negative electrode or a film covered with such a metal, in some embodiments, copper.

The negative-electrode active material may be any material that can intercalate and deintercalate lithium ions. Examples of the negative-electrode active material include carbon materials, metals, alloys, metal oxides, metal nitrides, and carbon and silicon containing an alkali metal. Examples of the carbon materials include natural graphite, artificial graphite, and pitch-based carbon fibers. Examples of the metals and alloys include lithium (Li), silicon (Si), tin (Sn), germanium (Ge), indium (In), gallium (Ga), bismuth (Bi), lithium alloys, silicon alloys, and tin alloys. Examples of the metal oxides that can be used as negative-electrode active materials include titanium oxide and niobium oxide.

Examples of the binder include fluorinated polymers and rubber polymers as in the positive electrode. In embodiments, the binder may be a styrene-butadiene copolymer (SBR), which is a rubber polymer, or a modified product thereof. The binder may be used in combination with a thickener, such as carboxymethyl cellulose (CMC).

Separator

The separator is an ion-permeable and insulating porous film disposed between the positive electrode and the negative electrode and is appropriately used in a lithium ion secondary battery of the present disclosure comprising a non-aqueous liquid electrolyte. Examples of the porous film include microporous thin films, woven fabrics, and nonwoven fabrics. In embodiments, the material of the separator may be polyolefin, more specifically, polyethylene, polypropylene, and polyamide-imides.

Shape of Lithium Ion Secondary Battery

The shape of the lithium ion secondary battery may, for example, be a coin-shape, a sheet-form (film-form), a folded shape, a wound cylinder with bottom, or a button shape, and is suitably selected depending upon the intended use.

Non-Aqueous Electrolyte

The non-aqueous electrolyte contains a non-aqueous solvent and an electrolyte salt that can dissolve in the non-aqueous solvent. The non-aqueous electrolyte may be an electrolytic solution, which is a liquid non-aqueous electrolyte, or a solid electrolyte. In embodiments, the non-aqueous electrolyte may bean electrolytic solution in terms of Li ion diffusion.

The electrolyte salt is a lithium salt, which is generally used as a supporting salt in known non-aqueous electrolyte secondary batteries. Such a lithium salt may be LiPF₆, LiBF₄, LiClO₄, LiAsF₆, LiCF₃SO₃, LiN(SO₂F)₂, and LiN(SO₂CF₃)₂, or combinations thereof. The lithium salt concentration in the electrolyte is, for example, 0.5 to 2 mol/L.

The non-aqueous solvent may be chosen among the group consisting of: cyclic ester carbonates, cyclic carboxylic acid esters, cyclic ethers, chain carbonic acid esters, chain carboxylic acid esters, chain ethers, nitriles, and amides. More specifically, the cyclic ester carbonates include ethylene carbonate (EC) and propylene carbonate (PC). The cyclic carboxylic acid esters include γ-butyrolactone (GBL). The chain esters include ethyl methyl carbonate (EMC) and dimethyl carbonate (DMC).

Alternatively, the non-aqueous solvent may be a fluorine-containing organic solvent (at least one hydrogen atom of which is substituted with a fluorine atom), because the fluorine-containing organic solvent is resistant to decomposition even in the case of charging to a high electric potential of more than 4.5 V. Examples of the fluorine-containing organic solvent include fluorine-containing cyclic ester carbonates, fluorine-containing cyclic carboxylic acid esters, fluorine-containing cyclic ethers, fluorine-containing chain carbonic acid esters, fluorine-containing chain ethers, fluorine-containing nitriles, and fluorine-containing amides. More specifically, the fluorine-containing cyclic ester carbonates include fluoroethylene carbonate (FEC), difluoroethylene carbonate (DFEC), and trifluoro propylene carbonate. The fluorine-containing cyclic carboxylic acid esters include fluoro-γ-butyrolactone (FGBL). The fluorine-containing chain esters include fluoroethyl methyl carbonate (FEMC), difluoroethyl methyl carbonate (DFEMC), and fluorodimethyl carbonate (FDMC).

All Solid-State Lithium Battery

In a further aspect, the present disclosure relates to an all-solid-state secondary lithium battery comprising the following elements:
a positive electrode containing the positive electrode active material with O6-type structure according to the present disclosure;
a solid electrolyte layer;
a negative electrode,
   wherein the solid electrolyte layer is positioned between the positive electrode and negative electrode.

In the basic structure of an exemplary all-solid-state battery, the following layers are arranged in order: positive electrode current collector, positive electrode, solid electrolyte, negative electrode, negative electrode current collector. Further layers may be present—for example, a buffer layer may also be interposed at the positive electrode/solid electrolyte interface in order to enhance lithium-ion transfer at the interface.

In the all-solid-state secondary lithium battery of the present disclosure, solid electrolyte may be added to the positive and negative electrodes as well as being present in the solid electrolyte layer. It may be noted here that solid electrolyte included in the positive electrode may be similar or different from the one included for negative electrode, and the solid electrolyte used as separator between positive and negative electrodes may be different from the ones included in the positive and negative electrodes.

Concerning the solid-state electrolyte, a certain number of oxide-based or sulfide-based materials are known. Oxide-based solid electrolyte materials for lithium all-solid-state batteries typically contain Li and O, and often also a transition metal and/or metal/metalloid from group 13/14 of the Periodic Table (e.g. Al, Si, Ge), and/or phosphorus. Known materials in this context include LiPON (for example, Li_{2.9}PO_{3.3}N_{0.46}), LiLaTiO, LiLaZrO (for example, Li₇La₃Zr₂O₁₂). Compounds which have a NASICON mold structure can also be mentioned e.g. the compound denoted by general formula Li₁₊ₓAlₓGe₂₋ₓ(PO₄)₃ (0≤x≤2), or the compound denoted by general formula Li₁₊ₓAlₓTi₂₋ₓ(PO₄)₃ (0≤x≤2). Another possibility is a lithium borosilicate.

Concerning sulfide-based electrolyte materials, known materials include ones containing Li, S, and possibly one or more of P, Si/Ge (also group 13 elements B, Al, Ga, In). Known possibilities include, for example, Li₁₀GeP₂S₁₂, Li₂S—P₂S₅ and Li₂S—P₂S₅—LiI, Li₂S—P₂S₅—Li₂O, Li₂S—P₂S₅—Li₂O—LiI, Li₂S—SiS₂ and Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n being positive numbers, Z being Ge, Zn, or Ga), Li₂S—GeS₂ and Li₂S—SiS₂—Li₃PO₄, and Li₂S—SiS₂-LiₓMO_{y} (where x and y are positive numbers, M is P, Si, Ge, B, aluminum, Ga, or In etc.) The description of the above “Li₂S—P₂S₅” refers to sulfide solid electrolyte materials which use the material composition containing Li₂S and P₂S₅ in varying relative amounts, the same naming convention referring to other descriptions hereinabove.

In an embodiment of an all-solid-state lithium battery, the negative electrode is Li metal. The Li metal may be in the form of Li foil or Li particles. The thickness of the negative electrode active material layer will generally be appropriately within the range of 0.1 μm to 500 μm.

As a positive electrode active material in an all-solid-state lithium battery according to the present disclosure, apart from the positive electrode active material with an O6-type structure according to the disclosure, a further compound may be used, such as LiCr_{0.05}Ni_{0.50}Mn_{1.45}O₄, LiCrMnO₄, LiNi_{0.5}Mn_{1.5}O₄, LiFePO₄, LiMnPO₄, LiNiPO₄, LiNi_{0.5}Mn_{0.5}O₂.

In an alternative embodiment, the positive electrode containing the positive electrode active material with an O6-type structure according to the disclosure, may also contain a cobalt-containing material such as LiCoO₂, LiNi_{0.33}Mn_{0.33}Co_{0.33}O₂, LiNi_{0.85}Co_{0.15}Al_{0.05}O₂, LiNi_{0.8}Mn_{0.1}Co_{0.1}O₂, LiNi_{0.6}Mn_{0.2}Co_{0.2}O₂ and LiNi_{0.8}Co_{0.2}O₂.

Furthermore, a positive active material layer may contain an electrically conductive agent from a viewpoint of improving the conductivity of a positive active material layer. As electrically conductive material, acetylene black, Ketjenblack, a carbon fiber, carbon nanotube (CNT), carbon nanofibers (CNF) etc. can be mentioned, for example. A positive active material may also contain a binding agent. As such a binding material (binding agent), fluorine-based binding materials, such as polyvinylidene fluoride (PVDF) and polytetrafluoroethylene (PTFE), etc. can be mentioned, for example. CMC, cellulose and similar biosourced binding agents can be used with water-based processes.

Although the thickness of a positive active material layer may change according to the kind of all-solid-state battery made, it may be within the range of 0.1 μm to 500 μm in embodiments.

Concerning solid electrolyte materials used for the negative electrode active material layer, and an electrically conductive agent, these may be the same as that for the solid electrolyte layer and positive active material layer mentioned above.

An all-solid-state battery of the present disclosure has at least the positive active material layer, solid electrolyte layer, and negative electrode active material layer which are mentioned above. It further usually has a positive current collector which collects a positive active material layer, and a negative pole collector which performs current collection of a negative electrode active material layer. As a material of a positive current collector, for example, SUS (stainless steel), aluminum, nickel, iron, titanium, carbon, etc. can be mentioned, and the material of the positive current collector may comprise SUS in some embodiments. On the other hand as a material of a negative pole collector, SUS, copper, nickel, carbon, etc. can be mentioned, for example, and the material of the negative pole collector may comprise SUS in some embodiments. Concerning the thickness, form, etc. of a positive pole collector and a negative pole collector, the person skilled in the art may choose suitably according to the use of the all-solid-state battery, etc. The cell case used for a common all-solid-state battery can be used, for example, the cell case made from SUS, etc. can be mentioned. Unlike the situation for a non-aqueous fluid electrolyte lithium ion secondary battery, a separator is not of particular use in an all-solid-state battery.

The all-solid-state battery of the present disclosure can be considered as a chargeable and dischargeable all-solid-state battery in a room temperature environment. Although it may be a primary battery and may be a rechargeable battery, in some embodiments, it is a rechargeable battery. Concerning the form of the all-solid-state battery, a coin type, a laminated type, cylindrical, a square shape, etc. can be mentioned, as examples.

### Examples

In what follows, the materials prepared were:
Example 1 (E1): Liₓ[Li_{1/6}Ni_{1/6}Mn_{4/6}]O_{y} (O6 phase)
Comparative Example 1 (CE1): Liₓ[Li_{0.14}Ni_{0.14}Mn_{0.72}]O₂ (O2 phase)
Comparative Example 2 (CE2): Liₓ[Li_{0.14} Ni_{0.14}Mn_{0.72}]O₂ (O3 phase)
Comparative Example 3 (CE3): Liₓ[Li_{1/6}Ni_{1/6}Mn_{4/6}]O_{y} (O3 phase)

Example 1 (E1), and Comparative Example 1 (CE1) were synthesized following Steps 0 to 3 as indicated below, adapting the amounts to the different stoichiometry of materials. Additional Step 4 is needed in order to synthesize the materials of Comparative Example 2 (CE2) and Comparative Example 3 (CE3).

### Synthesis of Materials

### Step 0: Preparation of Precursors

### Synthesis of Oxide Precursor from Nitrate

Ni(NO₃)₂,6H₂O→NiO(s)+2NO₂(g)+½O₂(g)+6H₂O(g)

Mn(NO₃)₂,6H₂O→MnO₂(s)+2NO₂(g)+6H₂O(g)

A heat treatment of 450° C. under O₂ atmosphere for 15 h was applied.

Sodium carbonate Na₂CO₃ and lithium carbonate Li₂CO₃ are dried overnight under vacuum at 200° C. for 15 h.

All materials were stored in an Ar filled glove box to avoid any air contamination. All the following steps were carried out in an inert atmosphere for similar reasons.

### Step 1: Synthesis of P2 Phase as for Example (E1)

Previously prepared oxide materials were added to dried carbonates in a grinding step which is advantageous in order to obtain well-mixed precursor powders with a random and homogenous distribution. Then, the mixed powder was placed in gold crucible for a heat treatment at 850° C. under O₂ atmosphere for a time between 15 h and several days. Thermal treatment of several days may give an improved particle size for the following steps.

It may be noted that a small additional amount (from 3% wt to 5% wt) of Li and Na carbonates is appropriately used in order to balance the alkaline evaporation during thermal treatment.

The synthesis follows the following chemical reaction:

x Na₂CO₃+y Li₂CO₃+2z NiO+2t MnO₂→2 P2-Naₓ[Li_{y}Ni_{z}Mnₜ]O₂+(x+y)CO₂(g)

Although oxygen is not consumed in the above reaction, it is appropriate to carry out the reaction under a flow of oxygen.

An appropriate ratio of the mass of Na₂CO₃ used in the above reaction to the mass of Li₂CO₃ is between 6 and 8, in embodiments, around 7 (i.e. the mass of Na₂CO₃ is around 7 times that of Li₂CO₃).

In embodiments, z may be from at least 0.15 to at most 0.17 and t from at least 0.66 to at most 0.69.

### Step 2: Solid State Ionic Na—Li Exchange

Previously prepared P2 phase was mixed with LiCl powder, with a small excess of LiCl of about 1.2 to 5 molar equivalents, in embodiments, 1.5 molar equivalents of LiCl for 1 mole of P2-Na_{5/6}[Li_{1/6}Ni_{1*6}Mn_{4/6}]O₂. Then, a grinding step was applied in order to obtain all precursor powders in a random and homogenous distribution. A uniaxial pressure of 2 to 7 tons is applied in order to form a compact pellet with the ground mixture. The pellet is then placed in an alumina crucible for a heat treatment under vacuum atmosphere (residual pressure 1×10⁻² mbar) at a temperature between 200° C. and 400° C., in embodiments, at 300° C., and for a time between 2 h to 15 h, in embodiments, 4 h. The reaction is summarized with the following chemical reaction:

P2-Naₓ[Li_{y}Ni_{z}Mₜ]O₂+(x+ε)LiCl→Liₓ[Li_{1/6}Ni_{1/6}Mn_{4/6}]O_{y}+εLiCl+x NaCl

### Step 3: Washing Step for Removing the Remaining Salts LiCl and NaCl

As a last step, a washing process is carried out in order to remove remaining LiCl and NaCl salts. In order to proceed with this washing step, the heated pellet is well ground and then placed in a solvent able to dissolve and remove remaining salts. In an appropriate embodiment, anhydrous methanol is used. This step is repeated from 2 to 5 times, in embodiments, 3 times.

### Step 4: O3 Type Active Material Synthesis from O2 or O6 Type Material as Precursor

Starting from previously obtained material an additional thermal treatment is applied for 15 h in a gold sealed tube at 400° C. for CE3 material and 450° C. for CE2 material.

Characterization of Materials

XRD Measurements

Laboratory powder X-Ray Diffraction (PXRD) patterns for E1, CE1, CE2 and CE3 were recorded on an Xpert3 diffractometer with an Xcelerator detector using a Cu Kα₁-Kα₂ source (λ=1.5418 Å) in the 20-range 10°-80° with a 0.016° step size over 3 hours. The samples were loaded in a glovebox in a Ø3 mm diameter borosilicate glass capillary sealed under argon. Synchrotron powder X-Ray Diffraction (SXRD) pattern for E1 was recorded at CRISTAL beamline at Soleil Synchrotron (France) using a wavelength λ=0.5130 Å and a MYTHEN detector. The pattern was recorded in the 20-range 0°-65° with a 0.004° step size over 1 minute. The sample was also loaded in a glovebox in a Ø3 mm diameter borosilicate glass capillary sealed under argon.

Simulation of XRD Diagrams

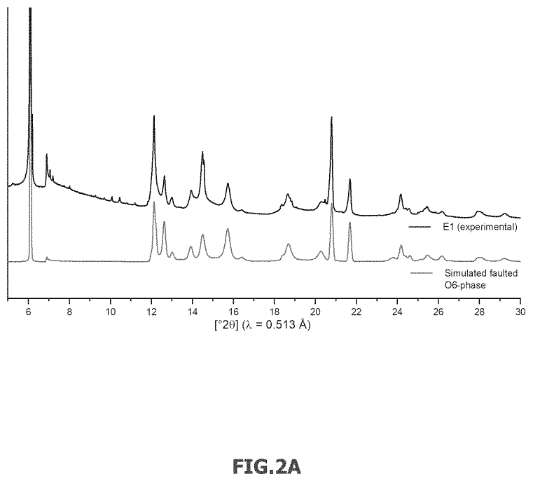

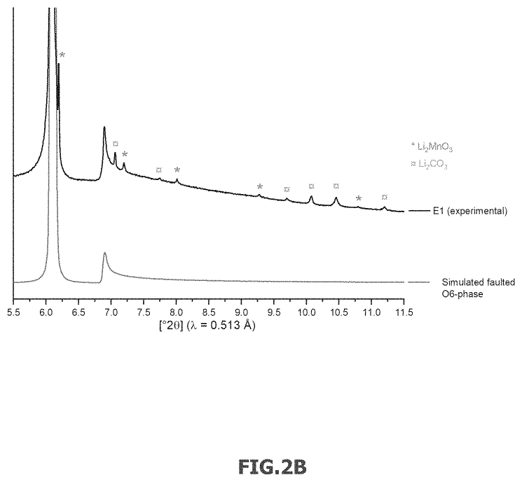

The FAULTS program (http://www.cicenergigune.com/faults) was used to simulate the SXRD pattern of the E1 sample. In this compound, it is proposed that the oxygen packing is not a perfect succession of ABCBCABABCACAB . . . layers (giving rise to the O6-type structure). Stacking defects occur periodically to locally give rise to the O2-type structure over a couple of layers. This latter structure type is usually obtained after the ion exchange from a sodium phase with the P2-type structure to a lithium phase. In order to test the proposition of O2-type stacking defects in the O6-type structure, a FAULTS program was used. It was found that a probably of having 10% of O2-type defects was a good approximation as the FIGS. 2A and 2B show a good agreement between the experimental SXRD pattern and the simulated one.

ICP-OES Measurements

The chemical analysis of the Na, Li, Ni and Mn contents was performed by inductively coupled plasma-optical emission spectroscopy (ICP-OES) using a Varian Model 720-ES spectrometer, after a complete dissolution of the powders into a concentrated aqua regia (HCl/HNO₃) solution and then diluted with distilled water.

Electrochemical Performances

The positive electrode was a mixture containing 88 wt. % of the active material, 10 wt. % of graphite-carbon black (50-50) mixture as electronic conductor and 2 wt. % of polytetrafluoroethylene (PTFE) as binder. The electrolyte was 1 M LiPF₆ in mixture of propylene carbonate (PC), ethylene carbonate (EC) and di-methylene carbonate (DMC) with an equal 33% vol ratio.

The electrochemical properties of the material were evaluated in CR2032-type coin cells. The assembled cells were cycled in galvanostatic mode using VMP-3 (Biologic) at a C/20 current rate in a range between [2.6V-4.6 V] and [2.5V-4.8V]. All the cell voltages are given vs Li⁺/Li redox couple.

TABLE 1
Cell parameters obtained from refinements performed using Le Bail method in
FullProf program and formula obtained by ICP-OES measurements

| | | Space | | | | |
|---|---|---|---|---|---|---|
| | ICP-OES deduced formulas | group | a (Å) | b (Å) | c (Å) | β (°) |
| E1 | Li_{0.86}[Li_{0.16}Ni_{0.16}Mn_{0.67}]O₂ | C2/m | 4.93(3) | 8.52(2) | 9.81(3) | 100.2(4) |
| CE1 | Li_{0.65}[Li_{0.12}Ni_{0.13}Mn_{0.74}]O₂ | P6₃/m | 4.92(3) | | 9.64(4) | |
| CE2 | Li_{0.65}[Li_{0.12}Ni_{0.14}Mn_{0.74}]O₂ | C2/m | 4.98(3) | 8.56(4) | 5.05(3) | 109.6(4) |
| CE3 | — | C/2m | 4.95(5) | 8.51(4) | 5.15(5) | 110.3(6) |

What is claimed is:

1. A positive electrode active material with O6-type structure having the following formula (1):
Liₓ[A_{z}B_{w}(Li_{1/6}Ni_{1/6}Mn_{4/6})_{1-z-w}]O₂ (1)
wherein
1≥x>0;
z<0.005;
when present, A is at least one element chosen from a group consisting of Mg, Ca, Sr, Sc, Y, La, Ti, Zr, Hf, V, Nb, Ta, Cr, Mo, W, Mn, Fe, Co, Zn, and Al;
w<0.05; and
when present, B is at least one element chosen from a group consisting of Mg, Ca, Sr, Sc, Y, La, Ti, Zr, Hf, V, Nb, Ta, Cr, Mo, W, Mn, Fe, Zn, and Al.

2. The positive electrode active material according to claim 1, wherein z=0 and/or w=0.

3. The positive electrode active material according to claim 2, wherein the positive electrode active material shows a monoclinic C2/m (12) space group, with the following cell parameters:
a=4.93 Å,b=8.52 Å,c=9.81 Å,β=100.2°.

4. The positive electrode active material according to claim 1, wherein a level of defect in the O6-type structure of the positive electrode active material is 40% or less.

5. The positive electrode active material according to claim 1, wherein a level of O2 type defect in the O6-type structure of the positive electrode active material is 10% or less.

6. The positive electrode active material according to claim 1, wherein A is cobalt.

7. The positive electrode active material according to claim 1, wherein A is 1≥x>0.5.

8. A preparation method of the positive electrode active material according to claim 1 comprising:
mixing, as a first step, a combination of oxygen-containing anion compounds of nickel, manganese, sodium and lithium, in a heating process in order to prepare a mixed oxide of sodium, lithium, nickel and manganese;
carrying out, as a second step, Na—Li ion exchange through application of a further lithium source to the mixed oxide of sodium, lithium, nickel and manganese prepared in the first step.

9. The preparation method according to claim 8, wherein the oxygen-containing anion compounds of nickel, manganese, sodium and lithium comprise oxides, hydroxides and/or carbonates.

10. The preparation method according to claim 9, wherein:
sources of the oxygen-containing anion compounds of nickel and/or manganese are oxides; and/or
sources of the oxygen-containing anion compounds of sodium and lithium are carbonates and/or hydroxides.

11. The preparation method according to claim 8 wherein:
in the first step, a combination of nickel oxide NiO and manganese oxide MnO₂ with sodium carbonate Na₂CO₃ and lithium carbonate Li₂CO₃ is mixed and heated at a temperature of 700° C. to 1000° C., for between 10 hours and 10 days; and
in the second step, the mixed oxide of sodium, lithium, nickel and manganese prepared in the first step is combined with lithium chloride (LiCl) powder, grinded, formed to a pellet and heated under vacuum at a temperature of at least 200° C. and at most 400° C. for at least 2 hours and at most 15 hours, in order to carry out solid state ionic Na—Li exchange and prepare a lithium-rich mixed oxide in a presence of lithium chloride and sodium chloride.

12. The preparation method according to claim 8, further comprising:
treating, as a third step, a lithium-rich mixed oxide in a presence of lithium chloride and sodium chloride obtained in the second step with a solvent to remove remaining lithium chloride and sodium chloride salts, in order to obtain a lithium-rich mixed oxide positive electrode active material.

13. The preparation method according claim 8, wherein a combination of nickel oxide NiO and manganese oxide MnO₂ is used in the first step and is prepared by:
preparing, as a prior step, a mixture of nickel oxide NiO and manganese oxide MnO₂ by heating of a mixture of nickel and manganese nitrates at a temperature of 350° C. to 550° C.

14. The preparation method according to claim 13 wherein, in the first step, the combination of nickel oxide NiO and manganese oxide MnO₂ with sodium carbonate Na₂CO₃ and lithium carbonate Li₂CO₃ is heated at a temperature of 800° C. to 900° C.

15. The preparation method according claim 13, wherein, in the prior step, the mixture of nickel and manganese nitrates is heated at a temperature of 400° C. to 500° C.

16. A positive electrode comprising:
the positive electrode active material according to claim 1; and
an electronically conductive material and/or a binder.

17. The positive electrode according to claim 16, further comprising at least one positive electrode active material selected from the group consisting of: LiCr_{0.05}Ni_{0.50}Mn_{1.45}O₄, LiCrMnO₄, LiNi_{0.5}Mn_{1.5}O₄, LiFePO₄, LiMnPO₄, LiNiPO₄, and LiNi_{0.5}Mn_{0.5}O₂.

18. The positive electrode according to claim 16, further comprising at least one positive electrode active material selected from the group consisting of: LiCoO₂, LiNi_{0.33}Mn_{0.33}Co_{0.33}O₂, LiNi_{0.85}Co_{0.15}Al_{0.05}O₂, LiNi_{0.8}Mn_{0.1}Co_{0.1}O₂, LiNi_{0.6}Mn_{0.2}Co_{0.2}O₂ and LiNi_{0.8}Co_{0.2}O₂.
